(19) United States
(12) Patent Application Publication
(10) Pub. No.: US 2025/0131490 A1
(43) Pub. Date: Apr. 24, 2025

(54) Account Virtualization System

(71) Applicant: Bank of America Corporation, Charlotte, NC (US)

(72) Inventor: Dean Iley, Chesapeake, VA (US)

(73) Assignee: Bank of America Corporation, Charlotte, NC (US)

(21) Appl. No.: 18/382,821

(22) Filed: Oct. 23, 2023

(51) Int. Cl. G06Q 40/02; G06Q 20/08

(52) U.S. Cl. CPC G06Q 40/02; G06Q 20/08

(57) ABSTRACT

Various aspects of the disclosure relate to creation and management of virtualized accounts. A virtualized account framework implemented on a computing platform provides an interface for real-time user configuration and account creation, deletion, and management actions. A core account may be linked to an existing account managed by an account management system or may be newly created. Each core account may be associated with a data structure defining one or more virtual accounts associated with the core account. Balance allocation from the core account to each of the virtual accounts, distribution limitations, balance limits from the core account to each of the virtual accounts may be defined by rules linked to the data structure. Virtual accounts, and in some cases, core accounts, may be redefined in real time, where account management upon reassignment is associated with a different account management system.

### BACKGROUND

Conventional financial accounts, such as checking accounts, savings accounts, brokerage accounts, and the like may be subject to several security and/or organizational problems. For example, compromised checking and/or savings accounts may be remedied via slow and/or complex manual processes which offer limited benefit to consumers. Often, in the name of convenience, consumers may willingly give their credentials to aggregators and merchants who may not be good stewards of that information. Once an account is compromised, the consumer may be required to close it and reopen a new account thus losing any ability to perform transactions while that remedial activity takes place. Additionally, the consumer has no ability to process trailing transactions. With respect to providing financial organizational opportunities for consumers, financial organizations require consumers to open multiple accounts to allow for separating portions of their balances for specific uses, such as sharing with a child or saving for a specific goal.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. General aspects include allowing consumers to digitize their account much like credit and debit cards in digital wallets and allow a consumer to establish an operational account with functional virtual accounts derived from it and under control of the operational account owner. This allows the consumer to close and/or create new accounts instantly with direct and traceable lineage to their original account allowing approved trailing activity to process normally and provide overall access control to the operational account owner.

Every financial institution aspires to enable access to a financial computing system that is easy for their customers to use. However, no present computing solution has addressed a primary inconvenience associated with banking—the need to own and operate multiple accounts to address their needs. The account virtualization system allows a consumer to securely operate a single account (e.g., a deposit account, a savings account, a checking account, and the like) for all of their consumer banking needs by digitally partitioning portions through one or more configurable sub-accounts (e.g., virtual accounts) for ease of use.

Present checking and savings account computing systems utilize fixed and otherwise static data from historical and legacy computing systems. For example, legacy computing systems utilize an account number as fixed identifier for a particular account. The account virtualization system, however, uses an account number as a point of entry into the system, which is a key to allow consumers to customize their funding arrangements. As such, the account virtualization system allows consumers to virtualize (e.g., digitize, tokenize, and the like) their financial accounts in a flexible and highly configurable manner. Here, the account virtualization provides a framework in which an account arrangement behind any fungible value associated with a core account may be customized per the desires of the consumer. Virtual accounts may be easily created and decommissioned in real-time, while retaining superior security attributes and allowing multiple uses with respect reference to the custom arrangement.

A numeric value that is presented to the world for payments and/or deposits, such as an account number) may be referenced in a unique and routable manner while providing a reference point to the customized consumer account arrangement.

The account virtualization system provides a framework where an account identifier (ID) may be virtualized. Historical computing systems used a static account number as an account ID that represented a single financial account. By using an account number in this way as the account ID, legacy computing systems exposed the account ID to compromise. By virtualizing the account number within the account virtualization system, an account number may be used in one or more electronic transactions or other electronic financial arrangements (e.g., recurring electronic payment transactions, one-time use electronic transactions) without exposing the actual account ID to outside computing systems.

Once an account ID within an account virtualization framework, the account virtualization system can generate as many virtual numbers as the consumer requires without, disturbing the lineage back to a core account. In an illustrative example, the account virtualization system may be used for different use cases. For example, the account virtualization system may be integrated within an enterprise computing system to integrate seamlessly with legacy computing systems. For example, the account virtualization system may be configured to designate an existing account number as a core account ID, where the user may access a user interface to create and manage a virtual number (e.g., a token) for distribution to approved electronic transaction systems. In some cases, the account virtualization system may issue new core accounts with both a core account ID and a token when a consumer opens a new account. Both use cases yield a fungible token (e.g., a virtual account identifier) that can be opened, closed, and/or replaced by the consumer in real-time without actually closing an account. While use of a legacy account number may have some risk associated with exposure of the account number, this risk is mitigated through use of virtualized tokens such that the core account ID may never be exposed to outside systems. Here, the account virtualization systems may be aligned with computing systems to which the legacy account number has been exposed, such as by replacing the core account number with a virtualized token. Additionally, the account virtualization system allows for seamless integration with legacy account computing systems (e.g., savings account computing systems, checking account computing systems, brokerage account computing systems) with disrupting millions of consumer accounts to offer virtualization of the consumer's existing electronic financial profile.

Another functionality provided by an account virtualization framework enabled via the account virtualization system allows the consumer to easily create and manage multiple tokens, in real time, for different purposes. Virtualizing an account ID may improve security measures, while simplifying account management tasks. Multiple virtual account creation through the account virtualization system allows a consumer to operate as if they had opened multiple accounts, but instead are simply managing those accounts from a single operational account (e.g., the core account ID) with rules and flexible access. One benefit of virtualizing accounts as ‘sub-accounts’ (e.g., virtual accounts) of an operational account is that there is no need to transfer money between accounts. The operational account can be set up with rules to automatically distribute funding to the sub-accounts. In some cases, the virtual account system framework can claw back money automatically by rule when the operational account needs funding. The user may also have the option, via a user interface such as an application or web portal, to manually manage aspects of the account virtualization process and/or allocation of funds between accounts. The virtual sub-accounts may be provisioned to merchants, person to person financial applications, and/or depositors with customizable security options. As such, the account virtualization framework allows the capability to only expose certain virtual accounts in specific and well-defined situations, so that only a specific virtual account need be closed in the event of compromise.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for an account virtualization system, according to one or more aspects described herein;

FIG. 1B shows an illustrative computing platform enabled for management of an account virtualization system, according to one or more aspects described herein;

FIG. 2 shows an illustrative process for virtual account creation, use, and management, according to one or more example arrangements; and

FIG. 3 shows an illustrative account virtualization system integrated within a financial transaction computing environment according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

The account virtualization system may facilitate chaining (e.g., structured lineage) of a virtualization arrangement regardless of electronic transaction activity related to an exposed account number. Further, an account virtualization framework may be capable of integrating existing account management computing systems so that existing accounts may be virtualized for use without changing anything about the existing account. Further, the account virtualization system may allow consumers to consolidate or merge multiple existing accounts within a same financial institution's computing network, for example, consumers could close many accounts held at the same institution in favor of consolidating to a secure operational account ID. In some cases, a main existing account may be designated as a core account ID and one or more other existing accounts may be associated with the core account ID, such as by being merged with a virtualized account. The account virtualization framework provided by the account virtualization system may allow consumers the ability to provide different account numbers to different requestors to isolate activity, where each of the different account numbers may be created or deleted in real-time. Further, an account transaction history can be summarized or federated per the consumers preference. Certain individuals, such as children or at-risk adults, may be given a virtualized account without having to own an account themselves. The account virtualization system may be extended further by leveraging existing transaction insights to help clients determine where they have exposed their current account or their virtual account to inform those users of a change in number.

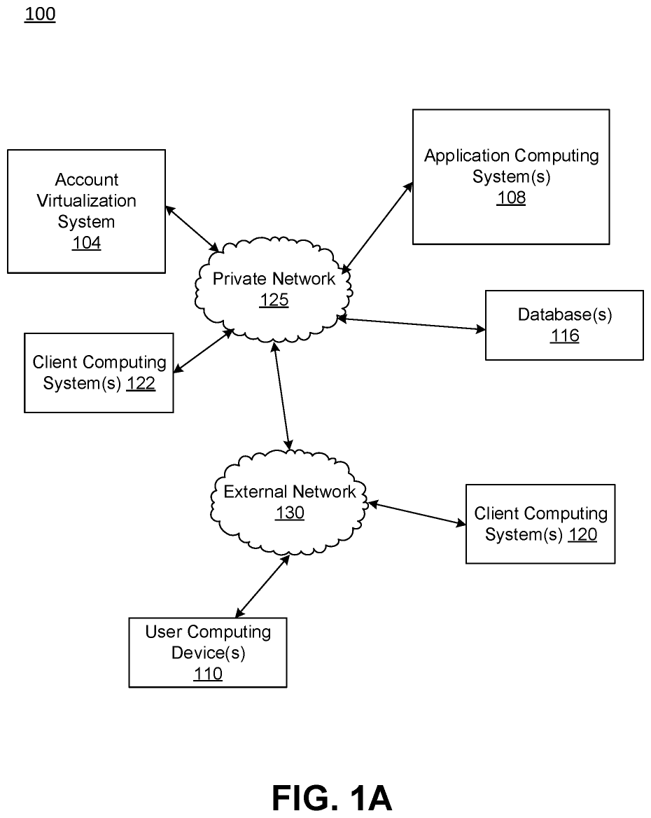

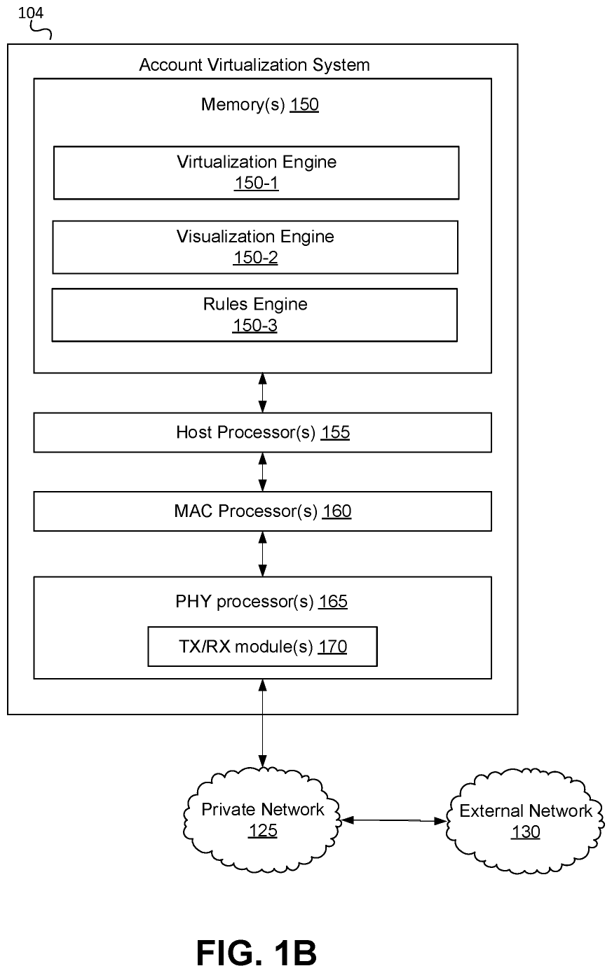

FIG. 1A shows an illustrative computing environment 100 for account virtualization, in accordance with one or more arrangements. The computing environment 100 may comprise one or more devices (e.g., computer systems, communication devices, and the like). The computing environment 100 may comprise, for example, an account virtualization system 104, one or more application computing system 108, one or more client computing systems 122, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A account virtualization system 104 as being a separate computing system, the account virtualization system may be incorporated within the one or more other computing systems, such as the application computing systems 108 and/or the client computing systems 122.

The account virtualization system 104 may comprise one or more computing devices and/or other computer components (e.g., processors, memories, communication interfaces) configured to perform one or more functions as described herein. Further details associated with the architecture of the account virtualization system 104 are described with reference to FIG. 1B.

The application computing systems 108 and/or the client system 122 may comprise one or more computing devices and/or other computer components (e.g., processors, memories, communication interfaces). In addition, the application computing systems 108 and/or the client system 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing system 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The client computing system 122 and/or the application computing systems 108 may comprise various servers and/or databases that store and/or otherwise maintain account information, such as financial account information including account balances, transaction history, account owner information, and/or other information. In addition, the client computing system 122 and/or the application computing systems 108 may process and/or otherwise execute transactions on specific accounts based on commands and/or other information received from other computer systems comprising the computing environment 100. In some cases, one or more of the client computing system 122 and/or the application computing systems 108 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing systems 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the account virtualization system 104. For example, the database(s) 116 may store virtual account structures, virtual account rules, and the like. In an arrangement, the database(s) 116 may be used for other purposes as described herein. In some cases, the client computing system 120 may write data or read data to the database(s) 116 via the services.

In one or more arrangements, the account virtualization system 104, the application computing systems 108, the client computing system 122, the client computing system 120, the user devices 110, and/or the other devices/systems in the computing environment 100 may be any type of computing device capable of receiving input via a user interface, and communicating the received input to one or more other computing devices in the computing environment 100. For example, the account virtualization system 104, the application computing systems 108, the client computing system 122, the client computing system 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the account virtualization system 104, the application computing systems 108, the client computing system 122, the client computing system 120, the user devices 110, and/or the other devices/systems in the computing environment 100 may, in some instances, be and/or comprise special-purpose computing devices configured to perform specific functions.

FIG. 1B shows an illustrative account virtualization system 104 in accordance with one or more examples described herein. The account virtualization system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The account virtualization system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the account virtualization system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the account virtualization system 104 may be configured to execute machine readable instructions stored in memory 150. The memory 150 may comprise (i) one or more program modules/engines having instructions that when executed by the one or more processors cause the account virtualization system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the account virtualization system 104 and/or by different computing devices that may form and/or otherwise make up the account virtualization system 104. For example, the memory 150 may have, store, and/or comprise a virtualization engine 150-1, a visualization engine 150-2, and a rules engine 150-3, and/or the like. The virtualization engine 150-1 may have instructions that direct and/or cause the account virtualization system 104 to perform one or more operations associated with creating and managing virtual accounts in near-real time. The visualization engine 150-2 may have instructions that may cause the account virtualization system 104 to facilitate user editing and management of a core account and one or more associated virtual accounts. The rules engine 150-3 may have instructions that may cause the account virtualization system 104 to facilitate use of one or more of the core account and/or virtual accounts based on customizable rules and/or thresholds associated with each account.

While FIG. 1A illustrates the account virtualization system 104 and/or the application computing systems 108, as being separate elements connected in the private network 125, in one or more other arrangements, functions of one or more of the above may be integrated in a single device/network of devices. For example, elements in account virtualization system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

As discussed above, the account virtualization system 104 may be used to associate an account (e.g., a core account with an associated account ID) with one or more virtual accounts. The virtual accounts may be created, removed and managed on-the-fly, e.g., in real time, by a user via a user interface that may be provided via a mobile application, a web browser interface or the like. The virtual accounts may allow the core account to never be exposed to external systems to reduce a likelihood of compromise. Each core account may be tokenized (e.g., virtualized) multiple times to enable “chests” and/or to support other users such as youths, compromised individuals, and the like. The account virtualization system 104 may provide a framework to manage virtual account associates, rules management, thresholds, and other limits, from a central computing environment. The virtual accounts may appear and operate similarly to legacy accounts supported by legacy computing systems of the application computing systems 108. In this way, the account virtualization system 104 may leverage existing application capabilities with little to no impact to the other computing systems within the enterprise computing network.

By associating the one or more virtual accounts with a core account, operational flexibility is maximized while minimizing impact to existing computing systems. For example, a root (or core) account will never change, but virtual accounts may be created and/or deleted instantaneously. The virtual accounts may be personalized such as by being associated with a particular vendor or electronic transaction type (e.g., a mortgage payment, a person-to person transaction, and the like), assigned for use by certain individuals (e.g., children), and/or assigned rules (e.g., deposit only, payment only, one-time use, and the like). Additionally, usage views may be isolated and/or aggregated to be viewed and/or managed via a dedicated user interface. Further, debit cards may be associated with one or more virtual accounts.

Users may opt-into the account virtualization system at account opening, for new accounts, or may be capable of assogmomg an existing account to be a core account. For example, the account number of the existing account may be assigned as, or incorporated into, the account ID of the core account. Once created, the core account may be provisioned immediately, where a robust self-service visualization may provide users with the ability to create, delete and manage their core account and virtual account(s) in real time. For example, users may be able to personalize use of their virtual accounts by setting spending limits, linking one or more debit cards, setting notification rules, setting transaction directionality, labeling accounts, and/or the like.

When created, the virtual account system may be managed in a way analogous to digital wallets, where the virtual account may be treated as a token. Transactions may be allocated from the operational account, where the use token (e.g., the virtual account) may be used to spend (e.g., payments) or for deposits. Virtual accounts may be closed, opened, and/or replaced instantly. In some cases, the virtual accounts, and/or the core account, may be used automatically for allocations required for transactions associated with different accounts, if configured. In some case, allocation instructions may be specified in rules associated with the core account and/or one or more virtual accounts. In general, users may source all funding from an operational (e.g., core) account with overridable holds to fund virtual accounts if desired. With respect to the enterprise network, the virtual account may be associated with an application computing system, where lookup services may enable management of operational and/or virtual accounts.

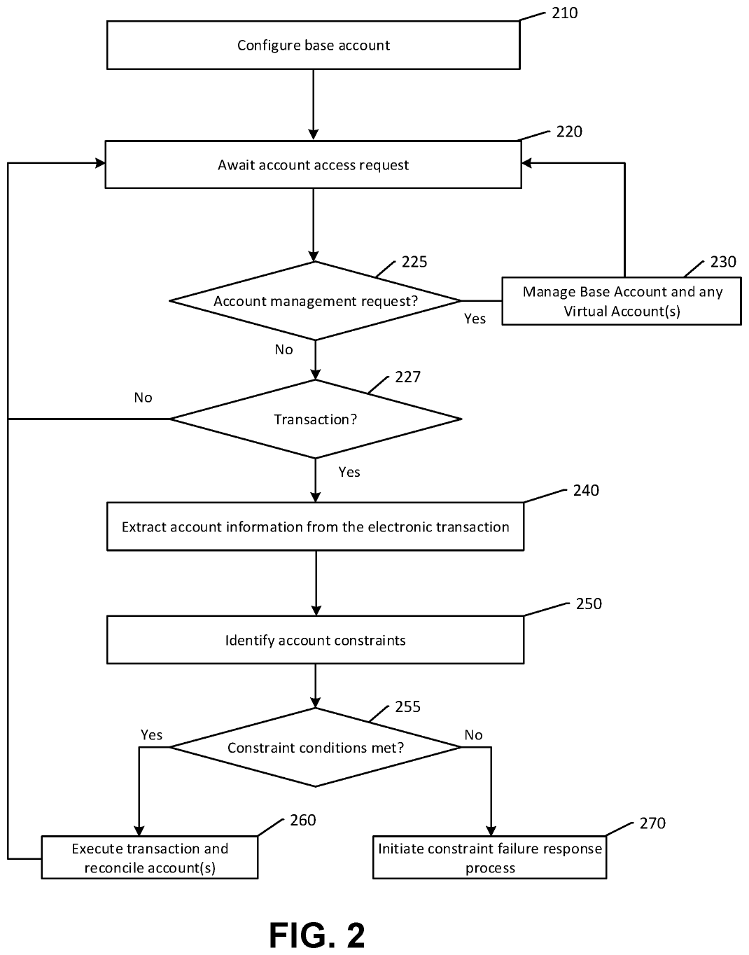

FIG. 2 show an illustrative process for creation and/or management of virtualized accounts, in accordance with one or more illustrative arrangements. At 210, a user may access a user interface via an application, a browser interface, and/or another user access method to configure a user account (e.g., a savings account, a checking account, a brokerage account, and the like) as a core account (e.g., a base account). For example, the core account number may form at least a part of the account ID. In some cases, the user may select an existing account (e.g., a legacy account) associated with one or more application computing systems 108 as the core account. In some cases, the core account may be newly created. In some cases, the virtual account system 104 may associate a base account number as a core account in an account virtualization data structure. At 220, the account virtualization system 104 waits for an account access request, such as a configuration request via a user interface and/or an electronic transaction reconciliation request from an application computing system 108. At 225, if the account access request is an account management request, the account virtualization system 104 initiates presentation of an account virtualization user interface at 230. For example, the account virtualization system 104 may cause an account application (e.g., a banking application on a user device 110) to present a user interface to allow real-time configuration of one or more virtual accounts. In some cases, the user application may access the core account information and present a user interface to allow editing of rules, creation, deletion and/or modification of virtual accounts, configuring account limits, and/or associating and/or editing of rules for electronic transactions for one or more of the core account and any associated virtual accounts. Processing then continues at 220 to await the next account access request.

If, at 227, when the account access request is not an account management request, the account virtualization system 104 determines whether the account access request is an electronic transaction request. If not, the account virtualization system 104 awaits a new account access request at 220. If, at 227, an electronic transaction request is identified, the account virtualization system extracts account information from the electronic transaction received from one or more application computing systems 108 at 240. At 250, the account virtualization system 104 then identifies account restraints based on an identification of the core account and/or an associated virtual account. If, at 255, the account virtualization system 104 recognizes that the constraint condition has not been met, a constraint failure response process is initiated by the account virtualization system 104. If, at 255, the account virtualization system 104 identifies that the constraint conditions are met, the electronic transaction request is executed by the associated application computing system 108 and/the account virtualization system 104 reconciles the core account and the one or more virtual accounts based on rules and/or virtual account configuration information.

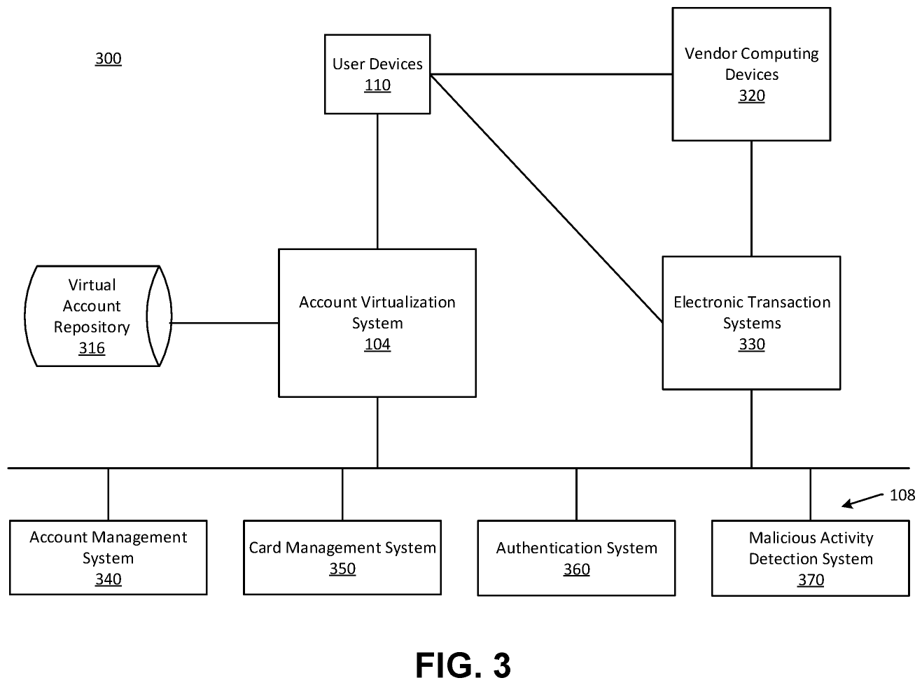

FIG. 3 shows an illustrative account virtualization system 104 integrated within a financial transaction computing environment 300 according to one or more aspects described herein. The financial transaction computing environment 300 may include one or more user devices 110 communicatively coupled via a network (e.g., the private network 125 and/or the external network 130 to the account virtualization computing system 104 to configure and/or manage account virtualization activities and/or the core account. The account virtualization system 104 may be communicatively coupled to a virtual account repository 316 storing account virtualization information, such as a plurality of account virtualization data structures. The user devices 110 may also be used by consumers to execute one or more electronic transaction, such as via vendor computing devices 320 (e.g., an internet-based vendor computing system) and/or via one or more electronic transaction systems 330 (e.g., a person to person electronic transaction system, a credit card transaction processing computing system, and/or the like).

The account virtualization computing system 104 and/or the electronic transaction computing systems 330 may be communicatively coupled to one or more of the application computing systems 108, such as an account management system 340, a card management system 350, an authentication system 360, a malicious activity detection system 370, and/or the like. For example, the account management system 340 may be a legacy account management computing system managing user accounts associated with particular electronic transaction activities, such as a checking account processing computing system, a savings account computing system, a brokerage account computing system and/or the like. The card management system 350 may manage one or more debit card accounts and may be associated with a legacy account, a core account, and/or one or more virtual accounts. The authentication system may manage user account authentication activities for users associated with user accounts, including the legacy accounts, the core accounts and/or the one or more virtual accounts. Additionally, malicious activity detection system may monitor electronic transaction activities and/or user account access activities associated with the legacy accounts, the core accounts, and/or the virtual accounts.

The account virtualization system 104 may generate virtual account numbers and/or newly created core accounts, where the account numbers assigned are the same as or similar to legacy account numbering systems. In some cases, a legacy account number generation computing system, of the application computing systems 108, may be leveraged to create a pool of virtual account numbers (e.g., tokens). In some cases, account tokens (e.g., virtual accounts) may be assigned to accounts on as-needed basis to efficiently assign and utilize the virtual account tokens. In some cases, virtual account creation may be offered with all new personal account openings. Existing account may be considered as core accounts, where virtual accounts may be assigned for users on an as-needed basis. Core accounts may be monitored as a separate process by the malicious activity detection system 370 due to possible past exposure to external computing systems.

In some cases, virtual to operational account conversion may be performed before a virtual account may be used as an operational account. This may allow the virtual account to be viewed as a customer account, where at creation, authorization and posting of the virtual account must be converted before funding. In some cases, a set of services may expose operational to virtual account relationships. A virtual account system of record may provide accountability for storing, maintaining, and provisioning of core accounts and virtual accounts. In some cases, legacy checking and/or savings computing systems (e.g., the account management system 340) may be assigned as a virtual account system of record. Such legacy computing systems may include database capability which can efficiently cross reference the operational account to its virtual accounts.

In some cases, the account virtualization system 104 may include virtual account classification functionality that may be used for identifying virtual accounts for functional activities and/or benefits. Here, the account virtualization system 104 may leverage an account attribute associated with an account key (e.g., a multi-part account key). The system may be populated with virtual and operational accounts associated with particular owners. Non-owners, like youths, may be assigned only virtual numbers. An entity portion of the key may align on the entity of the operational account. In some cases, the account attribute may be used as a decision key for the authentication systems 360 when identifying whether a user should be associated with a particular type of account (e.g., the core account, the virtual account).

In some cases, a number of virtual accounts associated with a particular core account may be unlimited, where the system may support unlimited virtual account tokens. In some cases, an upper bound (e.g., 5 virtual accounts, 10 virtual accounts, 20 virtual accounts, and/or the like) may be associated with a core account to reduce user configuration complexity or computer utility calculations. Statements and notices and/or reporting information may be generated based on an account type associated with each virtual account, where legacy reporting systems may be leveraged based on a classification associated with each virtual account. Virtual account and/or core account servicing may be easily paused, quarantined, and/or closed by the malicious activity detection system 370 when an indication of malicious activity has been identified.

During configuration, if a user opts into using the account virtualization functionalities, the account virtualization system 104 may associate a number of virtual accounts (e.g., 1, 2, 5, 10, and the like) to a core account, and each virtual account may be recorded in an account virtualization data structure stored in the virtual account repository 316. In some cases, virtual account maintenance activities may be managed by the account virtualization system 104 to close, add, and/or replace virtual accounts, each virtual account may be stored as a row in a data table, an element in a data structure or the like. In some cases, authorization of transactions associated with a virtual account may be converted to an operational account for decisioning. If, the data provisioning is performed in real time, the associated application computing system may utilize an internal cross-reference system and maintain data lineage information within a historical transaction data store. If limits are defined for one or more virtual accounts, the transaction processing computing system may enforce the limits based on the virtual account balance and/or status information as well as the operational account balance and/or status information. In some cases, other virtual account balance and/or status information may also be leveraged. Compromised and/or closed virtual accounts may be valid for processing selected transactions. For example, If the virtual account status is closed or compromised the account virtualization system 104 may check the operational (e.g., core) account for eligibility for requested transaction. In some cases, a posting application may be used as the system of record. The product code of a virtual account may be the trigger to convert. Posting may be subject to transaction rules on both virtual and operational accounts

Clients and Associates may view transactions related to one or more of the virtual accounts or the operational account. Additional views may be provided to view virtual account non-financial maintenance information. Transaction inquiries may be filtered to just those aligned to a specific virtual account (e.g., youth accounts) while other requests may be satisfied by retrieving all transactions related to the operational account. The balance on the operational account may have client initiated holds reducing the balance, such as for funding youth accounts. An override may be provided to re-allocate be available to take money reserved for certain virtual accounts. The authorization system may keep both balances updated and issue notices when override is executed. The virtual account status may be binding except for some business defined conditions. If the virtual status is defined as being ‘Active’ then the account virtualization system 104 may enforce the operational account status.

In some cases, allocations, preferences, privileges and/or constraints may be managed independently for virtual accounts. In some cases, certain rights and/or privileges may be based on a relationship code, where owners may set rules for distribution of credits to savings and/or shared accounts, as well as for transaction limits based on value, count, and/or a particular merchant or vendor. Transaction limits may be enforced similar to those of operational accounts. Virtual account usage may identify an intent of the sender and/or requestor to benefit enforcement of owner limit rules. In some cases, the system may initiate reconciliation between account based on a specified frequency, where results are logged to a centralized data repository. In some cases, recurring use may be identified by the account virtualization system 104, such that the account virtualization system 104 may be capable of identifying external systems configured to participate in recurring electronic transactions. For example, transaction data may be interrogated to determine recurring payments based on virtual account. A user interface may be presented to communicate this information customers and/or associates. In some cases, chaining capability may also be used as a basis to honor a request on a closed or compromised virtual account.

Ownership of accounts may be defined such that an operational account must be associated with an owner, co-owner, or trustee. A virtual account in a 1:1 relationship (e.g., a virtual account simply for security of the core account) would inherit the ownership role of the operational account. Virtual shared accounts may align to a youth role with reduced ownership privileges. In some cases, a virtual savings account may to refer to the operational account or possibly a distinction between owner and co-owner. In some cases, no constraints may be assigned to an operational account, thus anything in the operational account is available to be associated with a virtual account. In some cases, owners may have an ability to put holds on operational account funds and allocate funds to virtual accounts. An override function may be available to fund operational accounts in certain situations, such as when a case to cover certain payments (e.g., a mortgage payment) rather than reserving money in a virtual account.

In addition to an association between a core account identifier and one or more virtual accounts and for each virtual account, a virtual account data structure may include a three-part virtual account key including a virtual account entity data element, a virtual account product code (e.g., a debit card association), and a virtual account arrangement number. Other data elements may include a virtual account status indicator, a virtual account open date, a virtual account open time, a virtual account closed date, a virtual account closed time, a virtual account nickname (e.g., a youth name, a default description), an allocation percentage (e.g., a percentage of credit on the operational account received by the virtual account), a current balance element, a transaction limit element (e.g., a limit value, a velocity value, a merchant name, and the like), and a three part operational account key including an operational account entity element, an operational account product code element, and an operational account arrangement number element.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
an electronic transaction system providing, via a network, electronic transaction information associated with an account identifier (ID);
am account virtualization computing device, comprising:
a processor; and
memory storing computer-readable instructions that, when executed by the processor, cause the account virtualization computing device to:
identify, based on the electronic transaction information, one of a core account identifier and one or more virtual account identifiers associated with the core account identifier that corresponds to the account ID;
determine, based on a rule set associated with the core account identifier, whether the electronic transaction information meets threshold conditions defined by the rule set;
initiate, by the electronic transaction system and based on the electronic transaction information meeting the threshold conditions, completion of the electronic transaction; and
reconcile, when the account ID corresponds to a virtual account identifier, a first balance of the virtual account with a second balance of the core account.

2. The system of claim 1, further comprising a user device providing a user interface presenting a user interface screen comprising an input to initiate an account virtualization command, wherein the instructions cause the account virtualization computing device to:
identify, based on the account virtualization command, a core account identifier and one or more virtual account identifiers associated with the core account identifier;
generate, in real time and when the account virtualization command is a creation command, a new virtual account associated with the core account identifier.

3. The system of claim 1, further comprising a user device providing a user interface presenting a user interface screen comprising an input to initiate an account virtualization command, wherein the instructions cause the account virtualization computing device to:
identify, based on the account virtualization command, a core account identifier and one or more virtual account identifiers associated with the core account identifier;
deactivate, in real time and when the account virtualization command is a deletion command, an existing virtual account associated with the core account identifier.

4. The system of claim 1, further comprising a user device providing a user interface presenting a user interface screen comprising an input to initiate an account virtualization command, wherein the instructions cause the account virtualization computing device to:
generate, based on the account virtualization command corresponding to an account creation command, a core account identifier and an account virtualization data structure defining one or more possible virtual account identifiers associated with the core account identifier.

5. The system of claim 4, wherein the account creation command defines an existing account identifier managed by an account management computing system and wherein the account virtualization data structure links the core account identifier to the existing account identifier stored in the account management system.

6. The system of claim 1, further comprising a user device providing a user interface presenting a user interface screen comprising an input to initiate an account virtualization command, wherein the instructions cause the account virtualization computing device to:
link, based on the account virtualization command defining a virtual account classification as a deposit account, a virtual account to a deposit account management system.

7. The system of claim 6, wherein the instructions cause the account virtualization computing device to:
link, in real-time based on the account virtualization command redefining the virtual account classification as a savings account, the virtual account to a savings account management system.

8. The system of claim 6, wherein the instructions cause the account virtualization computing device to:
link, in real-time based on the account virtualization command associating a debit card to the virtual account, the virtual account to a card management system.

9. They system of claim 1, wherein the first balance of the virtual account comprises a defined allocation from the second balance of the core account.

10. A method comprising:
identifying, based on electronic transaction information received from an electronic transaction system, one of a core account identifier and one or more virtual account identifiers associated with the core account identifier;
determining, based on a rule set associated with the core account identifier, whether the electronic transaction information meets threshold conditions defined by the rule set;
initiating, by the electronic transaction system and based on the electronic transaction information meeting the threshold conditions, completion of the electronic transaction; and
reconciling, when the electronic transaction information corresponds to a virtual account identifier, a first balance of the virtual account with a second balance of the core account.

11. The method of claim 10, further comprising:
receiving, from a user device an input to initiate an account virtualization command;
identifying, based on the account virtualization command, a core account identifier and one or more virtual account identifiers associated with the core account identifier;
generating, in real time and when the account virtualization command is a creation command, a new virtual account associated with the core account identifier.

12. The method of claim 10, further comprising:
receiving, from a user device an input to initiate an account virtualization command;
identifying, based on the account virtualization command, a core account identifier and one or more virtual account identifiers associated with the core account identifier;
deactivating, in real time and when the account virtualization command is a deletion command, an existing virtual account associated with the core account identifier.

13. The method of claim 10, further comprising:
receiving, from a user device an input to initiate an account virtualization command;
generating, based on the account virtualization command corresponding to an account creation command, a core account identifier and an account virtualization data structure defining one or more possible virtual account identifiers associated with the core account identifier.

14. The method of claim 9, further comprising:
receiving, from a user device an input to initiate an account virtualization command;
linking, based on the account virtualization command defining a virtual account classification as a deposit account, a virtual account to a deposit account management system.

15. The method of claim 14, comprising linking, in real-time based on the account virtualization command redefining the virtual account classification as a savings account, the virtual account to a savings account management system.

16. The method of claim 14, comprising linking, in real-time based on the account virtualization command associating a debit card to the virtual account, the virtual account to a card management system.

17. They method of claim 10, wherein the first balance of the virtual account comprises a defined allocation from the second balance of the core account.

18. Non-transitory computer readable media storing instructions that, when executed by a processor, cause an account virtualization computing device to:
identify, based on electronic transaction information received from an electronic transaction system, one of a core account identifier and one or more virtual account identifiers associated with the core account identifier;
determine, based on a rule set associated with the core account identifier, whether the electronic transaction information meets threshold conditions defined by the rule set;
initiate, by the electronic transaction system and based on the electronic transaction information meeting the threshold conditions, completion of the electronic transaction; and
reconcile, when the electronic transaction information corresponds to a virtual account identifier, a first balance of the virtual account with a second balance of the core account.

19. The non-transitory computer readable media of claim 18, wherein the instructions cause the account virtualization computing device to:
receive, from a user device an input to initiate an account virtualization command;
identify, based on the account virtualization command, a core account identifier and one or more virtual account identifiers associated with the core account identifier;
generate, in real time and when the account virtualization command is a creation command, a new virtual account associated with the core account identifier.

20. The non-transitory computer readable media of claim 18, wherein the instructions cause the account virtualization computing device to:
receive, from a user device an input to initiate an account virtualization command;
link, based on the account virtualization command defining a virtual account classification as a deposit account, a virtual account to a deposit account management system.
